(19) United States
(12) Patent Application Publication
(10) Pub. No.: US 2016/0103500 A1
(43) Pub. Date: Apr. 14, 2016

(54) SYSTEM AND METHOD FOR A HUMAN MACHINE INTERFACE UTILIZING NEAR-FIELD QUASI-STATE ELECTRICAL FIELD SENSING TECHNOLOGY

(71) Applicant: STANLEY INNOVATION, INC., Merrimack, NH (US)

(72) Inventors: Patrick Hussey, Hollis, NH (US); Benjamin Shaffer, Bedford, NH (US)

(21) Appl. No.: 14/892,590

(22) PCT Filed: May 21, 2014
(86) PCT No.: PCT/US14/38920

§ 371 Date: Nov. 20, 2015

Related U.S. Application Data
(60) Provisional application No. 61/825,825, filed on May 21, 2013.

(51) Int. Cl. G06F 3/01; B25J 9/16; B25J 13/08; G06F 3/041

(52) U.S. Cl. CPC G06F 3/017; G06F 3/016; G06F 3/0416; B25J 9/1694; B25J 9/161; B25J 9/1676; B25J 9/1697; B25J 13/084; G06F 2203/04108; G06F 2203/04101; Y10S 901/09; Y10S 901/10

(57) ABSTRACT

The system and method for non-contact and/or touch-sensitive human machine interface, for use in numerous capacities wherein a lack of physical contact, with control apparatuses or devices is desirable. Electrical near field three-dimensional tracking and gesture control systems are utilized to interpret the location and movement of an operator, or to provide navigation, mapping, avoidance, localization, and the like for robotics applications.

### CROSS REFERENCE TO RELATED APPLICATIONS

This Application claims the benefit of U.S. Provisional Patent Application No. 61/825,825, filed May 21, 2013, the content of which is incorporated by reference herein in its entirety.

### FIELD OF THE INVENTION

The present invention relates generally to non-contact and touch-sensitive machine interface systems, and more particularly to an embedded system utilizing near field quasi-static electrical field sensing technology and a programmable microcontroller unit to serve as a non-contact and/or touch-sensitive human machine interface, or robotic obstacle detection system.

### BACKGROUND OF THE INVENTION

Individuals interact and interface with machines throughout the course of a day, and in order to provide an input to the machine, an individual must make physical contact with the machine. When an individual is required to make physical contact with the surface of a machine contamination of the surface occurs. This is particularly problematic in industries including, but not limited to, food and beverage, medical, laboratory, hospital, clean room environments, and the like where sanitation processes are highly regulated. When implementing a non-contact interface it is critical to tell how far from the surface a user's hand is to discriminate intended from un-intended gestures. Currently, systems require multiple sensors and expensive systems. Moreover, current non-contact technology lacks the ability to recognize complex gestures, which may be necessary for a variety of applications. For example, just as a physical button has a “detent” or a “click” when you press it that “detent” provides the -system a Z-axis measurement. A Z-axis measurement is necessary in non-contact systems to determine when someone “presses” a virtual button as well.

An example of a current touch-sensitive interface system is described in U.S. Pat. No. 5,679,934. There, a touchscreen is used to replace physical buttons. Current non-contact interface systems utilize a combination of ultrasonic, camera, infrared, capacitive, and laser sensing technology. These current technologies have limitations including, but not limited to, requiring threshold amounts of light, generating false hits, having blind spots, having fixed angles of view, and the like. See, for example, U.S. Pat. No. 8,547,360, which detects whether an object is present or not present, but is not capable of high-resolution location detection as described in the present invention. Regardless of the specific elements, current non-contact interlace systems possess particular limitations including the need for multiple sensing technologies. Some examples of optical systems are shown in U.S. Pat. Pub. No. 2008/0256494, and U.S. Pat. No. 8,340,815.

### SUMMARY OF THE INVENTION

One aspect of the present invention is a system comprising a plurality of sensing electrodes configured to transmit a set of electrical signals from the system to the operator and receive a set of electrical signals based on input from an operator of the system; at least one sensing integrated circuit; and a microcontroller unit; wherein the at least one sensing integrated circuit and the microcontroller unit are in electronic and data communication and wherein the microcontroller unit is configured to receive a set of three dimensional position data, raw/calibrated signal intensity data, a set of gesture data from the at least one sensing integrated circuit, or any combination thereof, wherein the microcontroller unit controls the at least one sensing integrated circuit and interprets information about an intended interaction of the operator with a device.

One embodiment of the human interface system is wherein the microcontroller and the at least one sensing integrated circuit are configured for calibration and frequency selection to provide interference correction.

One embodiment of the human machine interface system is wherein the at least one sensing integrated circuit functions as an electrical near field (“e-field”) three dimensional tracking and gesture controller to interpret the location and movement of an operator of the system that is detected by the plurality of sensing electrodes.

One embodiment of the human machine interlace system is wherein the human machine interface system is non-contact and touch-sensitive.

One embodiment of the human machine interface system is wherein the human machine interface utilizes specific algorithms for detecting changes in the emitted electric fields for the purpose of detecting and locating objects within the sensing area.

One embodiment of the human machine interface system is wherein the microcontroller unit includes a set of embedded computer software, wherein the embedded software may include application specific algorithms for interpreting input and device-specific communication protocols for input/output.

One embodiment of the human machine interface system is wherein the microcontroller unit is in electronic and data communication with the device and the microcontroller unit coordinates activities within the device and provides at least one feedback mechanism to the operator.

One embodiment of the human machine interface system is wherein the at least one feedback mechanism is selected from the group consisting of visual feedback, audible feedback, and tactile feedback.

One embodiment of the human machine interface system is wherein the microcontroller unit is in electronic communication with a plurality of sensing integrated circuits to enable larger sensing arrays.

One embodiment of the human machine interface system is wherein the sensing electrode array is placed in a nano-wire configuration in-front of an LCD utilizing the structures inside the LCD as the transmit and/or ground planes.

One embodiment of the human machine interface system is wherein the microcontroller unit determines when an input surface of the system has been physically touched, and potentially contaminated, by the operator.

One embodiment of the human machine interface system is wherein the system subsequently relays information to the operator relating to the potential contamination.

One embodiment of the human machine interface system is wherein the system subsequently initiates an auto-sanitization routine of the input surface.

One embodiment of the human machine interface system is wherein the microcontroller unit coordinates the execution of some function within the device based on the data collected and interpreted by the microcontroller unit from at least one sensing integrated circuit and the plurality of sensing electrodes.

One embodiment of the human machine interlace system is wherein the device is selected from the group consisting of a user control panel, an elevator ear operating panel a hall call station, a dispatch terminal, elevator passenger interface, a door, a robot, a robotic system, a robotic arm, a manufacturing station, a machine control panel, entry access control, a beverage dispensing machine, a snack, dispensing machine, operating room equipment, a clean room, an Automated Teller Machine (ATM), a fuel pump, and household appliances.

One embodiment of the human machine interface system further comprises an amplifier on one or more transmitting electrodes to boost transmitting power.

Another aspect of the present invention is a method of operating a device comprising providing a human machine interface system having a panel wherein the human machine interface is configured to detect, locate, and interpret user interaction; incorporating a microcontroller unit configured to interpret and abstract information from at least one sensing integrated circuit using software algorithms tailored to a specific application, device, and environment of the device; providing communication protocols and methods to tailor the interaction to the specific device by the microcontroller unit; providing a non-contact and touch-sensitive interface; and indicating when the panel has been touched to indicate that the surface of the panel is potentially contaminated.

One embodiment of the method of operating a device is wherein detecting a user interaction comprises a range from about zero to about fifteen centimeters distance from the non-contact interlace and the touch-sensitive interface.

One embodiment of the method of operating a device further comprises the step of initiating automated sanitization of the surface of the panel.

One embodiment of the method of operating a device is wherein indicating the surface of the panel is potentially contaminated comprises providing at least one feedback mechanism to the user.

One embodiment of the method of operating a device is wherein the device is selected from the group consisting of a user control panel, an elevator car operating panel, a hall call station, a dispatch terminal, elevator passenger interface, a door, a robot, a robotic system, a robotic arm, a manufacturing station, a machine control panel, entry access control, a beverage dispensing machine, a snack dispensing machine, operating room equipment, a clean room, an Automated Teller Machine (ATM), a fuel pump, and household appliances.

One embodiment of the method of operating a device is wherein detecting a user interaction comprises position and gesture data.

One embodiment of the method of operating a device further comprises executing a specific instruction to the device.

Another aspect of the present invention is a method of operating a robotic device comprising providing a plurality of sensing electrodes configured to transmit a set of electrical signals from the system to objects located in the robotic device's surroundings and receive a set of electrical signals based on input from a robotic device's surroundings; providing at least one sensing integrated circuit wherein the at least one sensing integrated circuit functions as an electrical near field (“e-field”) three dimensional tracking controller to interpret the location and movement of the system and objects located in the robotic device's surroundings that are detected by the plurality of sensing electrodes; and providing a microcontroller unit; wherein the at least one sensing integrated circuit and the microcontroller unit are in electronic and data communication and wherein the microcontroller unit is configured to receive a set of three dimensional position data, a set of gesture data, raw or calibrated received signal intensity data, or any combination thereof from the at least one sensing integrated circuit, wherein the microcontroller unit controls the at least one sensing integrated circuit and interprets information about an intended interaction of the system with a surroundings thereby providing navigation, mapping, avoidance, and localization to a robotic device.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a diagram of one embodiment of the system and method of the present invention illustrating the operation of a non-contact human machine interface.

FIG. 2 shows a flow diagram of one embodiment of the method of operation of a non-contact human interface system of the present invention upon providing an input to the system by an operator.

FIG. 3 shows one embodiment of the system of the present invention for use in robotics applications.

FIG. 4 shows one embodiment of the system of the present invention for use in robotics applications.

FIG. 5 shows one embodiment of the system of the present invention for use in elevator car operating panel applications.

FIG. 6 shows one embodiment of the system of the present invention for use in elevator car operating panel applications.

FIG. 7 shows one embodiment of the system of the invention providing a form of feedback to the user.

### DETAILED DESCRIPTION OF THE INVENTION

This disclosure describes methods and systems for a non-contact and/or touch-sensitive human machine interface. In certain embodiments, the present invention is useful as a human machine interface to an elevator control panel, elevator hail call station, and the like. In particular, the present invention implements an embedded system utilizing near field quasi-static electrical field sensing technology and a programmable microcontroller unit to serve as a non-contact and/or touch-sensitive human machine interface. In certain embodiments, the present invention is useful as a detection system for robotics applications to detect objects and/or digitally signed markers for navigation, avoidance, localization, mapping, and the like.

In certain embodiments of the present invention, the microcontroller unit is in data and/or electronic communication with an integrated circuit to collect, interpret and abstract three-dimensional position and/or gesture input from users of the system to interact with a device which performs a specific function. In certain embodiments, devices include, but are not limited to, elevator passenger control interfaces, such as elevator control panels, elevator call stations (e.g. located in a hallway), machinery and/or door interlaces located in sterile environments, vending machine/beverage fountain interfaces, dispatch terminals, a user control panel, a robot, a robotic system, a robotic arm, a manufacturing station, a machine control panel, entry access control, operating room, equipment, a clean room, an Automated Teller Machine (ATM), a fuel pump, kitchen equipment, household appliances and the like.

In certain embodiments, the present invention may serve as a plug and play replacement for an existing control panel for a particular machine or device. In these instances the microcontroller may communicate with the device over digital I/O, relays, serial data communication (CAN, Serial, SPI, Ethernet) and the like. Therefore, it is an object of the present invention to replace a typical physical interface, which requires physical contact to provide high-level input to a device that performs a specific function, with a non-contact human machine interface. In these applications, it is imperative that the replacement panel be backwards compatible with an existing user who is expecting to make physical contact with the interface (push a button). The present invention satisfies this need by having the ability to seamlessly transition from touch (contact) sensing to non-contact sensing. The present invention has the capability to train existing users on the new non-contact option by providing visual and/or auditory feedback prior to contact being made thus training the users that contact wasn't required to make a selection in a non-interruptive, un-obtrusive way.

It is another object of the present invention, to provide a non-contact human machine interface with the ability to sense input in a range of physical contact to the sensing surface up to a distance of approximately fifteen centimeters away from the sensing surface. It is another object of the present invention to function simultaneously as a touch-sensitive and non-contact interface to a device that performs a series of functions.

It is another object of the present invention to enable for the detection of a contaminated surface based on whether the system is in a touch-sensitive versus non-contact mode.

It is another object of the present invention to provide a simple and intuitive interface to select, navigate, and interact with machines or devices without the risk of cross contamination within a sterile environment.

It is another object of the present invention to provide a sensing system for a robotic platform or arm. In certain embodiments, the sensing system can detect objects as well as people entering the e-field detection zone. Utilizing this detection data, a control processor can halt or re-direct motion of a robotic platform or arm to prevent un-intended contact with objects and/or people.

In certain embodiments of the present invention, the system provides a replacement for a traditional touch screen overlay in-front of a standard display panel. The purpose of this embodiment is that it allows non-contact control where the buttons/inputs can be dynamic in nature. In certain embodiments, gestures and inputs may change the background image, which may intern change the behavior of a particular selection.

In certain embodiments of the present invention, a non-contact interface system has a microcontroller unit that contains programming to detect when there has been physical contact with the interface, and in turn enables the system to alert a user that the surface is no longer sterile and needs to be cleaned. In certain embodiments of the present invention, a non-contact interface system has a microcontroller unit that contains programming to detect when there has been physical contact with the interface, and in turn enables the system to initiate an automated sanitization of the surface.

In certain embodiments of the present invention, the automated sanitization function comprises a radiation-activated material and a source of radiation such as UV light. See, for example, U.S. Pat. Pub. No. 2007/0258852 and U.S. Pat. No. 8,597,569. In certain embodiments of the present invention, the automated sanitization function comprises an vibration source coupled to the touch-sensitive surface, wherein the vibration source generates pressure waves on the touch-sensitive surface to destroy and/or dislodge contaminants. See, for example, U.S. Pat. No. 7,626,579. In certain embodiments of the present invention, the automated sanitization function comprises a steam or liquid delivery system where the sanitizing liquid or gas is sprayed onto the surface via a small robotic arm. In the case of a liquid delivery system, an additional feature (e.g., a windshield wiper) could be used to remove the liquid from the surface.

Several advantages of the system of the present invention with respect to a the non-contact and touch-sensitive human machine interface systems include the ability to: a) detect, locate, and/or interpret user interaction from a distance of approximately zero to fifteen centimeters; b) incorporate a microcontroller unit which may interpret and abstract information from a sensing integrated circuit using software -algorithms tailored to a specific application, device, and/or environment; c) provide communication protocols and methods to tailor the interaction to a specific device by the microcontroller unit; d) provide a non-contact interface and a touch-sensitive interface in order to allow the system to be ADA compliant; e) indicate when a panel has been physically touched to indicate that the surface is potentially contaminated or even initiate an automated sanitization of the surface; and f) provides the ability to re-calibrate the system and alter the TX frequency if contamination or an object in the field causes interference or poor performance.

Additional advantages of the system of the present invention with respect to the non-contact and touch-sensitive human machine interface system include a) in button and/or panel replacement for elevators (e.g., the present system drastically lowers the complexity and weight over traditional buttons and/or panels), b) a common transmitter to allow for interference detection and rejection, c) automatic frequency detection and selection can prevent interference with other sensors and/or the environment, d) the system has the ability to place multiple sensors in close proximity, e) flat transmitter and receiver electrodes allow for easy integration into or behind existing panels, f) visual or auditory feedback can inform the user that a selection has been made before contact occurs, g) algorithms produce a highly accurate X, Y, Z position with a confidence metric to reduce false positives and to distinguish between configurable gestures produced by this data, and h) the system has the ability to be seamlessly integrated into an LCD using the base structures made of invisible indium tin oxide (“ITO”), or the like.

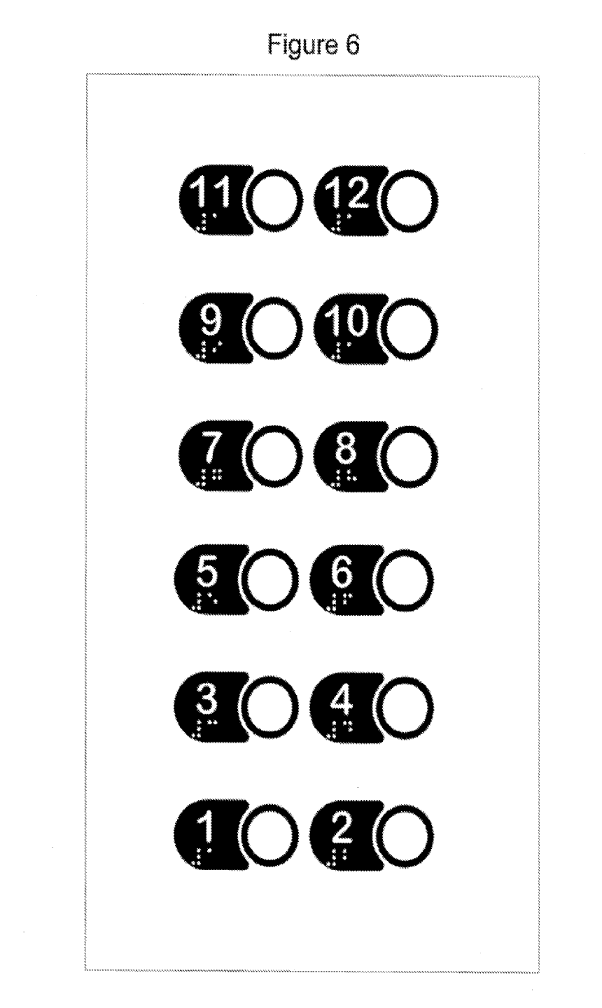

During the development of the present invention a method allowing the visually impaired to interface with a primarily non-contact panel was discovered. In certain embodiments of the present invention, the system has raised braille to allow the visually impaired to locate a selection. The system detects the movement of a hand passing over the panel in close proximity and uses a detection method whereby a selection is made by removing the hand from the sensing field over the desired selection, lingering over the desired selection, or by attempting to press on the desired selection. In this way a visually impaired individual is able to utilize the invention enabling the replacement of buttons in public locations where meeting ADA requirements are necessary. See, for example, FIG. 6 for one embodiment of a panel for use by the visually impaired.

In certain embodiments of the present invention, the system utilizes feedback in the form of a visual display, graphic LCD, individual LED lamps, audio, and the like to inform the user that the intended selection has been made before physical contact occurs. In certain embodiments, non-contact interfaces require a feedback system to take the place of what would typically be felt as either a button detent or a haptic type feedback to the user. Since no contact must occur in the present system, these traditional methods do not work and therefore a more advanced visual/audio feedback is needed.

In certain embodiments of the present invention, the system can be built into a visual display (e.g., LCD, plasma, amoled and the like). The electrodes can utilize structures already present in an LCD display such as a display's existing coating (e.g., ITO) or custom electrodes placed in the LCD enclosure in-front of, around or behind the display.

In certain embodiments of the present invention, the system is reconfigurable through software. For instance, a system can receive large gestures such as swipe until a particular menu is located. Once that menu is activated the system can switch into an X, Y, Z localization to allow cursor like movement for more detailed input or button selection. In certain embodiments, the system combines multiple sensing systems to allow for simultaneous input from both hands of the operator. In certain embodiments in the case of a robot, the non-contact system can switch from obstacle detection and avoidance to hand tracking/following after a particular gesture is received.

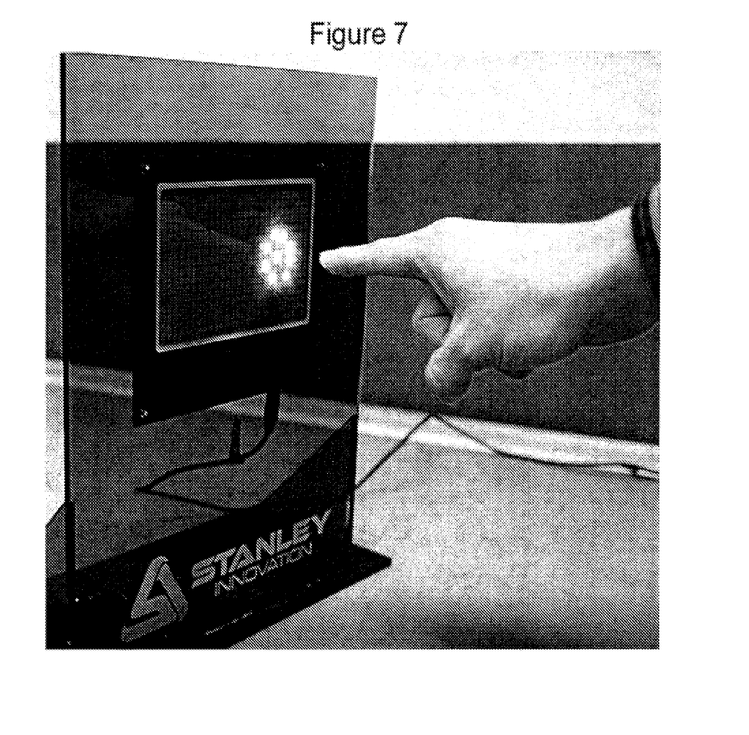

In certain embodiments of the present invention, an indicator in proximity to the selection, which increases in intensity as the user approaches a selection, is used. In certain embodiments, continued presence or a quick removal from that location can confirm the selection. In certain embodiments, a selection may be indicated by a flash, continued luminance of mat selection, or the like. In certain embodiments, moving away from the indicated location prior to confirmation can cause the intensity to decrease. In certain embodiments, a decrease in intensity can confirm either the user's intention to select something else or can visually draw the user back to the desired selection. In certain embodiments of the present invention, a central LED is activated and with continued presence additional LEDs around the central LED are activated to form a “target” to provide feedback to the user that their selection has been made. See, for example, FIG. 7. In certain embodiments, gestures such as scrolling or rotating to select an input are utilized. In certain embodiments, a gestured based password can grant access to the user or provide input to the device. In certain embodiments of the present invention, non-visual forms of feedback can be produced. In certain embodiments, the system of the present invention is configured to discriminate between a user making a selection and some other extraneous movement or approach. In certain embodiments of the present invention, a graphic LCD or the like provides user feedback.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. For a better understanding of the invention, its operating advantages and the specific objects attained by its uses, reference should be made to the accompanying drawings and descriptive matter in which there are illustrated preferred embodiments of the invention. To the accomplishment of the foregoing and related ends, certain illustrative aspects are described herein and these aspects are indicative of the various ways in which the principles disclosed herein can be practiced and ah aspects and equivalents thereof are intended to be within the scope of the claimed subject matter.

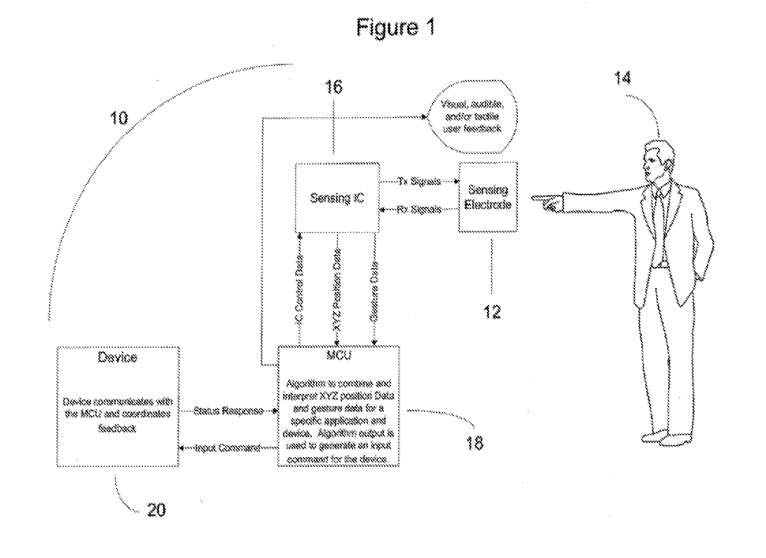

FIG. 1 illustrates a non-contact human -machine interface system 10 and associated method of operation, wherein the system 10 comprises a plurality of sensing electrodes 12 disposed to receive a set of electrical signals based on input from an operator 14 of the system 10, and transmit a set of electrical signals from the system 10 to the device 20.

The system 10 further includes a sensing integrated circuit 16, wherein the sensing integrated circuit 16 preferably functions as an electrical near field (“e-field”) three dimensional tracking and gesture controller, or the like, to interpret the location and movement of an operator 14 of the system 10 that is detected by the plurality of sensing electrodes 12. The sensing integrated circuit 16 is in electronic and data communication with a microcontroller unit 18, wherein the microcontroller unit 18 is disposed to receive a set of three dimensional position data, raw/calibrated signal intensity data along with a set of gesture data or any combination thereof from the sensing integrated circuit 16. Preferably, the microcontroller unit 18 controls the sensing integrated circuit 16 and interprets information about an intended interaction of the operator 14 with a device 20.

In certain embodiments, the microcontroller receives calibration, configuration, and other data from the sensing integrated circuit to provide greater accuracy and reduces stray capacitance problems. In certain embodiments, if the instrument surface becomes contaminated or a static object enters the field for a period of time the microcontroller initiates a calibration of the sensors to eliminate the effect of the object. Also if the sensor experiences interference at the transmit frequency the microcontroller can detect this and change the transmit frequency.

Furthermore, in one embodiment of the present invention, the microcontroller unit 18 includes a set of embedded computer software, wherein the embedded software may include application specific algorithms for interpreting input and device specific communication protocols or input/output. Additionally, the microcontroller unit 18 may coordinate with the device 20 via electronic and data communication at least one feedback mechanism to the operator 14, including; but not limited to visual, audible, tactile, or any other similar means. The microcontroller unit may coordinate between multiple sensing systems to provide feedback to one or more devices.

In yet another embodiment, the microcontroller unit 18 may interpret when an input surface of the system 10 has been physically touched by the operator 14, and subsequently relay this information to call for sanitization and/or warn users of contamination of the input surface. The device 20 is in data and electronic communication with the microcontroller unit 18, wherein the device 20 coordinates with the microcontroller unit 18, which in-turn coordinates the execution of some function, based on the data collected and interpreted, from the sensing integrated circuit 16 and the plurality of sensing electrodes 12.

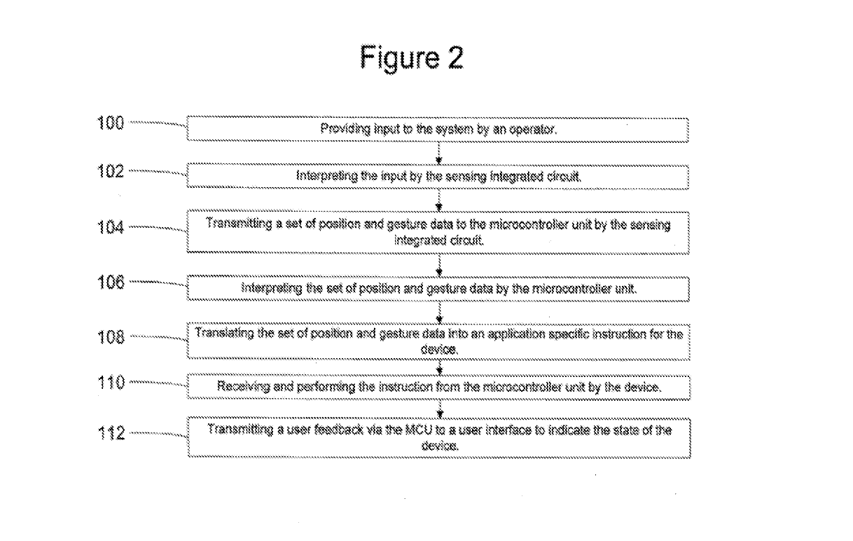

FIG. 2 illustrates a flow diagram of one embodiment of the method of operation of the non-contact human machine interface system 10. Initially, at step 100, an input is provided to the system by the operator 14, wherein the operator 14 may provide an input via a series and/or combination of gestures and position at a range of zero to fifteen centimeters away from the plurality of sensing electrodes 12. At step 102, the input by the operator 14 is interpreted by the sensing integrated circuit 16; once the input is interpreted, at step 104 the sensing integrated circuit 16 transmits a set of position and gesture data preferably via electronic communication to the microcontroller unit 18.

At step 106, the microcontroller unit 18 interprets the position, signal strength, and gesture data sent by the sensing integrated circuit 16. At step 108, following interpretation of the position and gesture data, the microcontroller unit 18 translates the input data and provides an abstracted application specific instruction for the device 20. At step 110, the device 20 receives the specific instruction from the microcontroller unit 18 via electronic communication, and subsequently executes the specific instruction. Finally, at step 112, the device 20 initiates and transmits a user feedback via the microcontroller unit 18 to a user interface to indicate to the operator 14 the state of the device 20.

On aspect of this method of non-contact input is that it provides a gentle and accommodating learning curve tor new users. A new untrained user can interact with the same control panel in a standard touch mode. Using feedback (LEDs, LCD, audio, and the like) the user can be alerted that their input was accepted before contact is made. Over time the user is taught by the system that contact is not necessary. In certain embodiments, this allows for implementation where interaction will occur with the general public and specific training is not possible or feasible. The public understands how to make a selection via directly pushing a button and the system of the present invention provides those users a smooth, self-taught transition to a non-contact model.

In certain embodiments, the system and associated method of operation may be implemented in a variety of environments in conjunction with the specific operation required of that location. In certain embodiments, a human machine interface, with a sensing distance of approximately zero to fifteen centimeters, is applied in environments where physical contact would result in the risk of contamination. In one embodiment, the system may be utilized in replacing a push-button elevator user interface and/or hall call station wherein the system is able to provide a combined touch-sensitive/non-contact interface for inputting commands to the elevator control system (i.e. the device). In certain embodiments, the system may be utilized in replacing the push-button vending machine or touch screen soda fountain interface to provide a combined touch-sensitive/non-contact interface for inputting commands to the vending machine or soda fountain (i.e. the device).

In certain embodiments of the present invention, the sensing distance of the non-contact and/or touch-sensitive interface is from about 0 cm to about 15 cm. In certain embodiments of the present invention, the sensing distance of the non-contact and/or touch-sensitive interface is about 0 cm, about 1 cm, about 2 cm, about 3 cm, about 4 cm or about 5 cm. In certain embodiments of the present invention, the sensing distance of the non-contact and/or touch-sensitive interface is about 6 cm, about 7 cm, about 8 cm, about 9 cm, about 10 cm or about 11 cm. In certain embodiments of the present invention, the sensing distance of the non-contact and/or touch-sensitive interface is about 12 cm, about 13 cm, about 14 cm, about or about 15 cm.

During development of the system, a method of detection was discovered that lends itself to the visually impaired. In certain embodiments of the method of detection, the user's hand is tracked and a selection is recorded when the user's hand is withdrawn over a particular selection. This is in contrast to typical detection models where the selection is made as a user's hand approaches and/or reaches its minimum distance from the detection surface.

In yet another embodiment of the present invention, the system may be utilized in replacing the push-button interface for machinery in sterile environments such as a cleanroom manufacturing, a laboratory, a hospital, food and beverage manufacturing, a door, and the like. Furthermore, in combination with any of the above embodiments, the addition of an automated sanitization system may be used to sanitize a surface to which the proposed invention has detected physical contact.

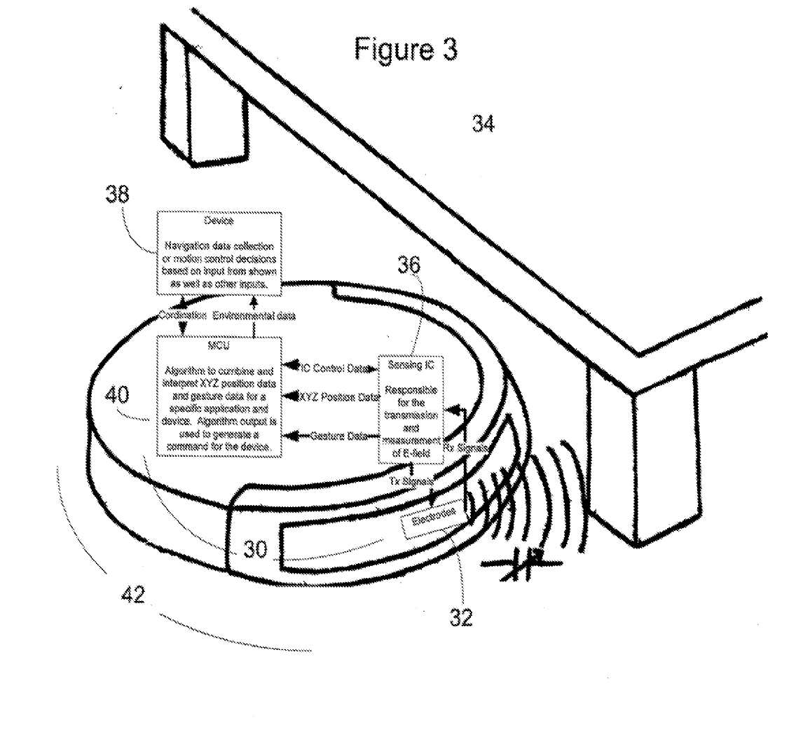

In certain embodiments of the present invention, e-field sensing technology is used in the Held of robotics to detect objects and/or digitally signed markers for navigation, avoidance, localization, mapping, and the like. Referring to FIG. 3, one embodiment of the system of the present invention for use in robotics applications is shown. More particularly, a non-contact interface system 30 and associated method of operation, wherein the system comprises a plurality of sensing electrodes 32 disposed to receive a set of electrical signals based on input from the surroundings 34 of the overall system 42. The sensing integrated circuit 36 is in electronic and data communication with a microcontroller unit 40, wherein the microcontroller unit 40 which is disposed to receive a set of control data, three dimensional position data, raw/calibrated signal intensity data, and a set of gesture data, or any combination thereof from the sensing integrated circuit 36. Preferably, the microcontroller unit 40 is in electronic and data communication with the device 38 to which it provides information about the environment so that the device 38 can control the overall system 42 to adjust the course of the robot to avoid or purposefully engage an object in the environment.

The system further includes a sensing integrated circuit 36, wherein the sensing integrated circuit 36 preferably functions as an electrical near field (“e-field”) three dimensional tracking and gesture controller, or the like, to interpret the location and movement of objects and or people in the surroundings 34 of the system 30 that are detected by the plurality of sensing electrodes 32. For this purpose, a signed marker (not shown) made up of a conductive pre-defined pattern can be used to identify and locate objects or people in the surroundings 34 of the system 30.

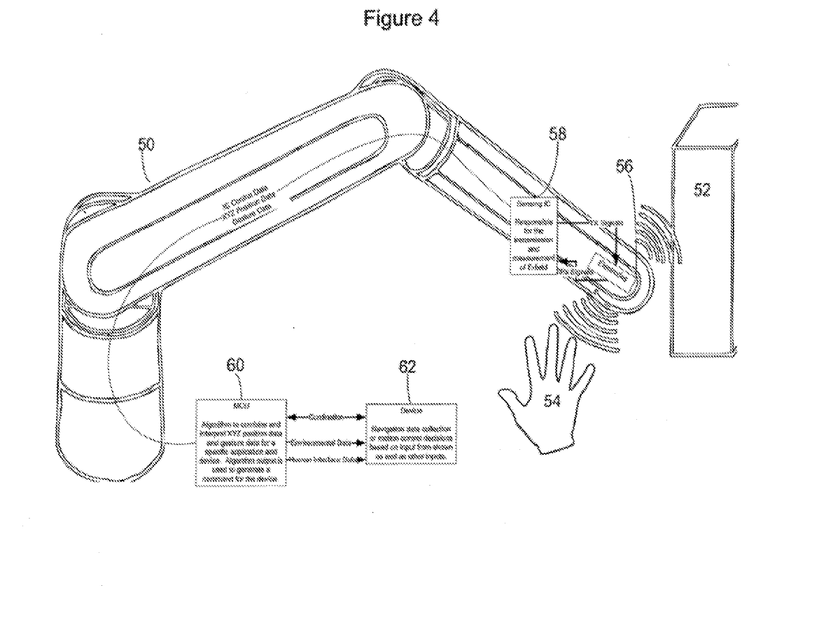

Referring to FIG. 4, one embodiment of the system of the present invention for use in robotics applications is shown. More particularly, a non-contact interface system comprised of a plurality of sensing electrodes 56, a sensing integrated circuit 58, and a microcontroller 60 are disposed to detect objects or people in the environment and guide the motion of a robotic arm 50. With the information provided by the microcontroller unit 60 the device 62 can control the motion of the robotic arm to avoid an object 52 or a person 54. Alternatively the microcontroller can interpret gesture commands provided by the person 54 to the sensing electrodes 56 and detected by the sensing integrated circuit 58. These gesture commands can then be sent to the device 62 to function as a human machine interface.

Furthermore, in one embodiment of the present invention, the microcontroller unit 18, 40, 60 includes a set of embedded computer software, wherein the embedded software may include application specific algorithms for interpreting input and device specific

communication protocols or input/out. Additionally, the microcontroller unit 18, 40, 60 may coordinate with devices via electronic and data communication and/or provide at least one feedback mechanism to the surroundings 34, 52, 54, including, but not limited to visual, audible, tactile, or any other similar means.

In certain embodiments of the present invention, an e-field sensor is used to detect objects 34, 54, 52 in the path of a mobile robot 42 or robotic arm 50. On a robotic platform, detection of objects in the robot's path prior to contact is very important to prevent damage to those objects and/or the robot. For large, high speed vehicles, sensors like laser range finders work well, however, their cost and complexity prevent them from being used on smaller, low-speed robots. Utilizing quasi-static electrical near Held sensing to detect objects and change the robot's course prior to contact is an important improvement over current systems.

In certain embodiments of the present invention, an e-field sensor is used to detect objects near the end effector of a robotic arm or manipulator. When industrial robots are in motion the system needs to detect potential collisions of the end effectors and arm. Electrical near field works well in this application to replace light curtains, IR sensors, ultrasonic sensors, and the like. With electrical near field, the system will know that there is a nearby object and the system will have information about where that object is/was located and how to avoid it. Additionally, electrical near field works well for allowing the machine to detect and focus in on a potential target object for the robot utilizing markers, which create specific electrical field signatures.

In certain embodiments of the present invention, an e-field sensor is used for localization and mapping in semi-autonomous applications. In certain embodiments, the system identifies and defects strategically placed dynamically adjustable digitally signed markets (or creating recognizable signatures of obstacles) to guide a robotic platform through an environment. Prior art systems utilize RF tags and IR sensing to navigate and coordinate distributed mobile systems within an environment, such as distribution facilities, but they have limitations including, but not limited to, requiring a separate sensing system for identification from avoidance. In the case of IR, dirt, alignment, and power draw all reduce the reliability of the system. Utilizing a single sensing system, as in the present invention, preserves precious space on a robot and simplifies the overall system.

In certain embodiments of the present invention, an e-field sensor is used for human-robot interactions. In certain embodiments, a near field, non-contact interface is used as a method tor high-level interaction with a robotic system. Some examples of high-level interaction are guiding a robot by having the robot closely follow a human hand, intuitive gestures for stop, move, and follow, and the like. Additional uses of the present invention allow for robotic control in hostile environments where ingress protection makes buttons impractical or where the requirement for gloves renders existing touch screens un-usable.

In certain embodiments of the present invention, the system is vandal resistant. In these embodiments, if the non-contact system is placed behind a high impact scratch resistant plastic or glass then damaging the input from repeated presses or striking the system with an object such as a cane will not degrade the effectiveness of the input over time.

In certain embodiments of the present invention, the system works with gloved hands. This is particularly important as today's common capacitive touch displays and system do not work with non-conductive gloves.

In certain embodiments of the present invention, the system makes it easy to create a moisture -resistant enclosure. Mechanical buttons and membrane switches rely on thin moving mechanical parts that eventually fail. In certain embodiments of present invention, the system can work through the wall of the enclosure so that no sealing materials are required.

In certain embodiments of the present invention, the system needs no moving pans and therefore its MTBF (Mean time between failures) is much higher.

In certain embodiments of the present invention, the system can be flat, raised, recessed, and the like. In certain embodiments of the present invention, the system can be auto calibrated.

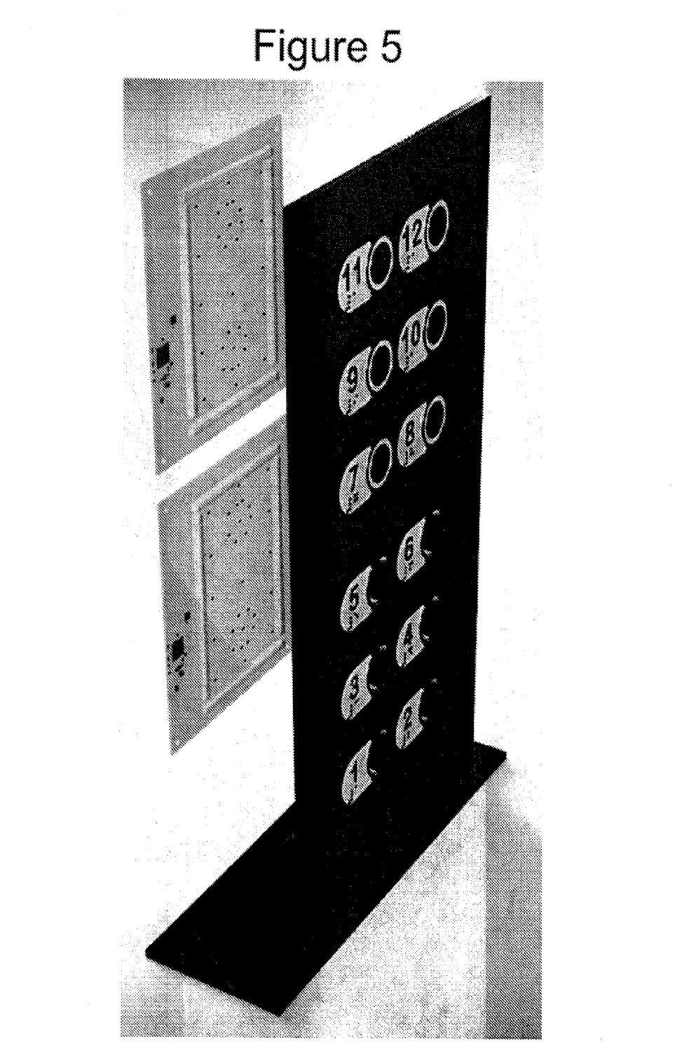

Referring to FIG. 5, one potential embodiment of the invention mounted on two printed circuit boards behind an impact resistant elevator passenger interface panel is shown. This figure demonstrates that in certain embodiments of the present invention, multiple sensing circuits can be used in close proximity for the purpose of expanding the sensing area.

In certain embodiments of the present invention, the system is utilized to replace the activation sensors on a beverage-dispensing machine.

In certain embodiments of the present invention, the system is utilized to replace the visual display and/or existing touch sensitive control on modern beverage and/or snack dispensing machines.

In certain embodiments of the present invention, the system is utilized for door control either to command a door open/closed or to prevent the automatic door from striking a person.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A human machine interface system comprising:
a plurality of sensing electrodes configured to transmit a set of electrical signals from the system to the operator and receive a set of electrical signals based on input from an operator of the system;
at least one sensing integrated circuit; and
a microcontroller unit; wherein the at least one sensing integrated circuit and the microcontroller unit are in electronic and data communication and wherein the microcontroller unit is configured to receive a set of three dimensional position data, raw/calibrated signal intensity data, a set of gesture data, or any combination thereof from the at least one sensing integrated circuit, wherein the microcontroller unit controls the at least one sensing integrated circuit and interprets information about an intended interaction of the operator with a device.

2. The human machine interface system of claim 1, wherein the at least one sensing integrated circuit functions as an electrical near field (“e-field”) three dimensional tracking and gesture controller to interpret the location and movement of an operator of the system that is detected by the plurality of sensing electrodes.

3. The human machine interface system of claim 1, wherein the microcontroller and the at least one sensing integrated circuit are configured for calibration and frequency selection to provide interference correction.

4. The human machine interface system of claim 1, wherein the human machine interface system is non-contact and touch-sensitive.

5. The human machine interface system of claim 1, wherein the human machine interlace utilizes specific algorithms for detecting changes in the emitted electric fields for the purpose of detecting and locating objects within the sensing area.

6. The human machine interface system of claim 1, wherein the microcontroller unit includes a set of embedded computer software, wherein the embedded software may include application specific algorithms for interpreting input and device-specific communication protocols for input/output.

7. The human machine interface system of claim 1, wherein the microcontroller unit is in electronic and data communication with the device and the microcontroller unit coordinates activities within the device and provides at least one feedback mechanism to the operator.

8. The human machine interface system of claim 1, wherein the at least one feedback mechanism is selected from the group consisting of visual feedback, audible feedback, and tactile feedback.

9. The human machine interface system of claim 1, wherein the microcontroller unit is in electronic communication with a plurality of sensing integrated circuits to enable larger sensing arrays.

10. The human machine interface system of claim 9, wherein the sensing electrode array is placed in a nano-wire configuration in-front of an LCD utilizing the structures inside the LCD as the transmit and/or ground planes.

11. The human machine interface system of claim 1, wherein the microcontroller unit determines when an input surface of the system has been physically touched, and potentially contaminated, by the operator.

12. The human machine interface system of claim 11, wherein the system subsequently relays information to the operator relating to the potential contamination.

13. The human machine interface system of claim 11, wherein the system subsequently initiates an auto-sanitization routine of the input surface.

14. The human machine interface system of claim 1, wherein the microcontroller unit coordinates the execution of some function within the device based on the data collected and interpreted by the microcontroller unit from the at least one sensing integrated circuit and the plurality of sensing electrodes.

15. The human machine interlace system of claim 1, wherein the device is selected from the group consisting of a user control panel, an elevator car operating panel, a hall call station, a dispatch terminal, elevator passenger interface, a door, a robot, a robotic system, a robotic arm, a manufacturing station, a machine control panel, entry access control a beverage dispensing machine, a snack dispensing machine, operating room equipment, a clean room, an Automated Teller Machine (ATM), a fuel pump, and household appliances.

16. The human machine interface system of claim 1, further comprising an amplifier on one or more transmitting electrodes to boost transmitting power.

17. A method of operating a device comprising
providing a human machine interface system having a panel wherein the human machine interface is configured to detect, locate, and interpret user interaction;
incorporating a microcontroller unit configured to interpret and abstract information from at least one sensing integrated circuit using software algorithms tailored to a specific application, device, and environment of the device;
providing communication protocols and methods to tailor the interaction to the specific device by the microcontroller unit;
providing a non-contact and touch-sensitive interface; and
indicating when the panel has been touched to indicate that the surface of the panel is potentially contaminated.

18. The method of operating a device of claim 17, wherein detecting a user interaction comprises a range from about zero to about fifteen centimeters distance from the non-contact and touch-sensitive interface.

19. The method of operating a device of claim 17, further comprising the step of initiating automated sanitization of the surface of the panel.

20. The method of operating a device of claim 17, wherein indicating the surface of the panel is potentially contaminated comprises providing at least one feedback mechanism to the user.

21. The method of operating a device of claim 17, wherein the device is selected from the group consisting of a user control panel, an elevator ear operating panel, a hail call station, a dispatch terminal, elevator passenger interface, a door, a robot, a robotic system, a robotic arm, a manufacturing station, a machine control panel, entry access control, a beverage dispensing machine, a snack dispensing machine, operating room equipment, a clean room, an Automated Teller Machine (ATM), a fuel pump, and household appliances.

22. The method of operating a device of claim 18, wherein detecting a user interaction comprises position and gesture data.

23. The method of operating a device of claim 17, further comprising executing a specific instruction to the device.

24. A method of operating a robotic device comprising
providing a plurality of sensing electrodes configured to transmit a set of electrical signals from the system to objects located in the robotic device's surroundings and receive a set of electrical signals based on input from a robotic device's surroundings;
providing at least one sensing integrated circuit wherein the sensing integrated circuit functions as an electrical near field (“e-field”) three dimensional tracking controller to interpret the location and movement of the system and objects located in the robotic device's surroundings that are detected by the plurality of sensing electrodes; and
providing a microcontroller unit; wherein the at least one sensing integrated circuit and the microcontroller unit are in electronic and data communication and wherein the microcontroller unit is configured to receive a set of three dimensional position data, raw/calibrated signal intensity data, a set of gesture data from the sensing integrated circuit, or any combination thereof, wherein the microcontroller unit controls the at least one sensing integrated circuit and interprets information about an intended interaction of the system with a surroundings thereby providing navigation, mapping, avoidance, and localization to a robotic device.
